(19) United States
(12) Patent Application Publication
(10) Pub. No.: US 2013/0204752 A1
(43) Pub. Date: Aug. 8, 2013

(54) SYSTEM AND METHOD FOR TRACKING INVENTORY OF TIRE COMPONENTS AT POST-PRODUCTION FACILITY

(71) Applicant: Scott Damon, Brentwood, TN (US)

(72) Inventor: Scott Damon, Brentwood, TN (US)

(21) Appl. No.: 13/758,964

(22) Filed: Feb. 4, 2013

Related U.S. Application Data
(60) Provisional application No. 61/595,969, filed on Feb. 7, 2012.
(60) Provisional application No. 61/595,980, filed on Feb. 7, 2012.
(60) Provisional application No. 61/595,985, filed on Feb. 7, 2012.
(60) Provisional application No. 61/595,987, filed on Feb. 7, 2012.
(60) Provisional application No. 61/595,990, filed on Feb. 7, 2012.
(60) Provisional application No. 61/595,997, filed on Feb. 7, 2012.

(51) Int. Cl. G06Q 10/08

(52) U.S. Cl. CPC G06Q 10/087
USPC 705/28

(57) ABSTRACT

An inventory control method and system tracks components of a new tire which may include a new tire casing and a new tire tread at a point-of-sales facility where the new tire can be assembled. A new tire casing with a first machine-readable identifier and a new tire tread with a second-machine readable identifier are provided. The components are delivered to the point-of-sale facility where their arrival and exit can be tracked by reading the respective first machine-readable identifier and second machine-readable identifier. In various embodiments, the tire control method and system can reallocate components between a plurality of point-of-sale facilities, generate reports on inventory usage, etc. In some embodiments, the inventory control method and/or system can be carried out with the assistance of a computer system configured with an inventory control program for tracking the components.

### CROSS-REFERENCE TO RELATED APPLICATIONS

This patent application claims the benefit of priority to:
(1) U.S. Provisional Patent Application No. 61/595,969, filed on Feb. 7, 2012, and entitled “System and Method for Decentralized Manufacture of New Tires Enabling Improved Performance Characteristics”;
(2) U.S. Provisional Patent Application No. 61/595,980, filed on Feb. 7, 2012, and entitled “System and Method for Customizing Vehicle Tires on Demand at Point-of-Sale”;
(3) U.S. Provisional Patent Application No. 61/595,985, filed on Feb. 7, 2012, and entitled “System and Method for Reducing Point-of-Sale Tire Inventory”;
(4) U.S. Provisional Patent Application No. 61/595,987, filed on Feb. 7, 2012, and entitled “System and Method for Tracking Inventory of Tire Components at Point-of-Sale Facility”;
(5) U.S. Provisional Patent Application No. 61/595,990, filed on Feb. 7, 2012, and entitled “System and Method for Pricing, Leasing and Transferring Ownership of Tires”; and
(6) U.S. Provisional Patent Application No. 61/595,997, filed on Feb. 7, 2012, and entitled “System and Method for Customizing and Manufacturing Tires Near Point-of-Sale,”
   which are incorporated in their entireties herein by this reference.

### BACKGROUND OF THE INVENTION

Pneumatic tires are found on most road-bound vehicles and occasionally must be replaced due to wear or damage. Tires may also need to be replaced as seasonal weather patterns change so that the performance characteristics of the tire are suited to the weather conditions. New replacement tires can be obtained at various point-of-sale facilities such as tire shops or vehicle maintenance and repair locations. The demand for replacement tires can be large and unpredictable. For example, operators of large fleets of vehicles such as over-the-road trucking companies, delivery and shipping companies, bus transportation companies and the like may need to replace tires often and promptly in order to continue fleet operations.

Additionally, replacement tires are available in a variety of styles, sizes and performance characteristics so that customers can select new replacement tires according to their preferences and/or according to the intended application. Accordingly, a large number of tires may need to be kept in inventory to promptly meet demand. The inventory of tires on hand can be very large, in some instances filling a warehouse at or near the point-of-sale facility. From a business standpoint, however, maintaining large inventories requires a large capital investment and is usually undesirable.

Another option for replacing worn tires is retreading an existing tire. In a retreading operation, the worn tread is removed from the outer circumference of the existing tire and replaced with a new tread. Retreading may not be an available option if the body of the tire is damaged. Retreading is also generally not an option for passenger automobiles.

Accordingly, there is a need to reduce the inventory of new tires at a point-of-sale facility. However, there is a competing need to ensure that a sufficient number of new tires in various style and types are available at the point-of-sale facility to promptly satisfy the customer demand. The present disclosure is directed to realizing these and other needs.

### SUMMARY OF THE DISCLOSURE

In one embodiment, an inventory control system for tracking inventory of tire components is described. A tangible, computer-readable medium having computer-executable instructions stored thereon is provided. The computer-executable instructions comprise an inventory control application. A processor is adapted to execute the inventory control application contained on the computer-readable medium. A data storage device is operably arranged with the processor. The data storage device is adapted to store tire component inventory data.

A plurality of tire casings is provided. Each tire casing includes a machine-readable casing identifier that is associated with the tire casing and includes casing identification data. A plurality of tire treads is provided. Each tire tread includes a machine-readable tread identifier that is associated with the tire tread and includes tread identification data.

A reader is provided that is adapted to read the machine-readable casing identifiers and the machine-readable tread identifiers. The reader is arranged with the processor and is adapted to transmit a tire component identification data signal to the processor upon reading each of said identifiers. The tire component identification signal includes the respective identification data. The inventory control application includes computer executable instructions that are adapted to update the tire component inventory data in the data storage device in response to receiving the tire component identification data signal.

In another embodiment, a computer-implemented method for tracking inventory of tire components at a post-production facility is described. A first list of tire casings at a post-production facility and a second list of tire treads at the post-production facility are maintained in computer readable memory. A first indication that a tire casing has arrived at the post-production facility is received. A second indication that a tire tread has arrived at the post-production facility is received. The first list and the second list are respectively incremented to reflect the arrival of the tire casing and the tire tread at the post-production facility in response to receiving the first and second indications.

In still another embodiment, a method for tracking inventory levels of tire components at a post-production facility is described. A first machine-readable identifier associated with a tire casing entering the post-production facility is read. In response to reading the first machine-readable identifier entering the post-production facility, a tire casing tally is increased by one unit. A second machine-readable identifier associated with a tire tread entering the post-production facility is read. In response to reading the second machine-readable identifier entering the post-production facility, a tire tread tally is increased by one unit. The tire casing and the tire tread are combined to form a new tire.

The first machine-readable identifier and the second machine-readable identifier are read when the tire casing and the tire tread exit the post-production facility as the new tire. In response to reading the first machine-readable identifier exiting the post-production facility, the tire casing tally is decreased by one unit. In response to reading the second machine-readable identifier exiting the post-production facility, the tire tread tally is decreased by one unit.

Further and alternative aspects and features of the disclosed principles will be appreciated from the following detailed descriptions and the accompanying drawings. As will be appreciated, the principles related to systems and methods for tracking inventory of tire components at a post-production facility, such as a point-of-sale facility, for example, disclosed herein are capable of being carried out in other and different embodiments, and are capable of being modified in various respects. Accordingly, it is to be understood that the foregoing general description and the following detailed description is exemplary and explanatory only and does not restrict the scope of the disclosed principles.

### BRIEF DESCRIPTION OF THE SEVERAL VIEWS OF THE DRAWINGS

FIG. 1 is a fragmentary perspective view, in section, of an embodiment of a pneumatic tire according to principles of the present disclosure including a new tire casing and a separate new tire tread for assembly to the casing.

FIG. 2 is a transverse cross-sectional view of the tire of FIG. 1.

FIG. 3 is a perspective view illustration of an embodiment of first and second machine-readable identifiers in the form of a radio frequency identification tag and a reader.

FIG. 4 is a schematic diagram of an embodiment of an inventory control system for distributing new tire casings and treads among a number of point-of-sale facilities constructed according to principles of the present disclosure.

FIG. 5 is a screen display of an embodiment of a graphical user interface screen of a tire customization and price calculating program through which a customer can select tire components to form a customized new tire following principles of the present disclosure.

FIG. 6 is a flow chart illustrating steps of an embodiment of a method for carrying out an inventory control system according to the principles of the present disclosure.

### DETAILED DESCRIPTION OF PREFERRED EMBODIMENTS

In some embodiments, the disclosure provides systems and methods for tracking inventory for use with a method of producing tires at post-production facilities, including point-of-sale facilities, from new tire casings and separate new tire treads assembled together at the facility. To track the inventory, a first machine-readable identifier can be associated with the tire casing at the time of manufacture and a second machine-readable identifier can be associated with the tire tread at the time of its manufacture. When the tire casing and tire tread arrive at the point-of-sale facility, the respective first and second machine-readable identifiers are read to record arrival of the components. This information may be communicated to a computer system for tracking purposes. If the tire casing or tire tread are selected for assembly into a new tire, the respective first or second machine-readable identifier is read a second time to record that the respective component is exiting the point-of-sale facility. This information can also be transmitted to the computer system that can update the inventory records to reflect the change in inventory at the point of sale facility. In various embodiments, the inventory control system can be used to replenish inventory at the point-of-sale facility, reallocate inventory among different point-of-sales facilities or generate reports regarding inventory usage at the point-of-sale facilities.

An inventory control system following principles of the present disclosure can help ensure that tire casings and tire treads are in inventory at a point-of-sale facility to timely meet customer demand for new tires. The inventory control system can monitor inventory among a plurality of point-of-sale facilities and can reallocate inventory in response to one point-of-sale facility having a depleted inventory of a particular tire component, for example. These and other possible advantages of the disclosure will become apparent from the foregoing description and the accompanying drawings.

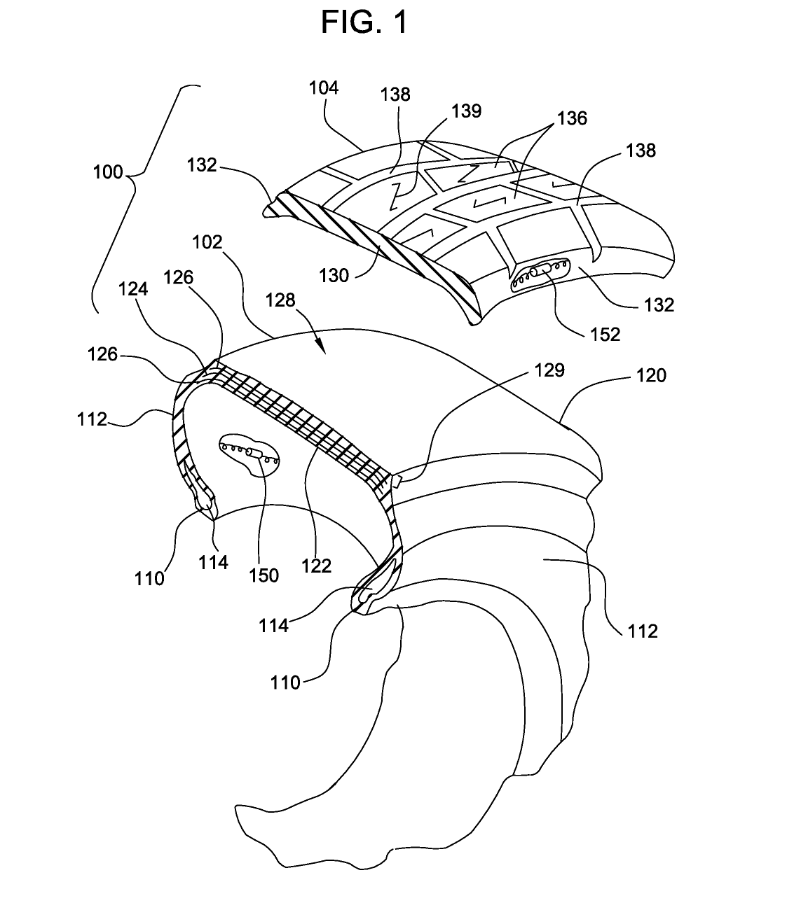

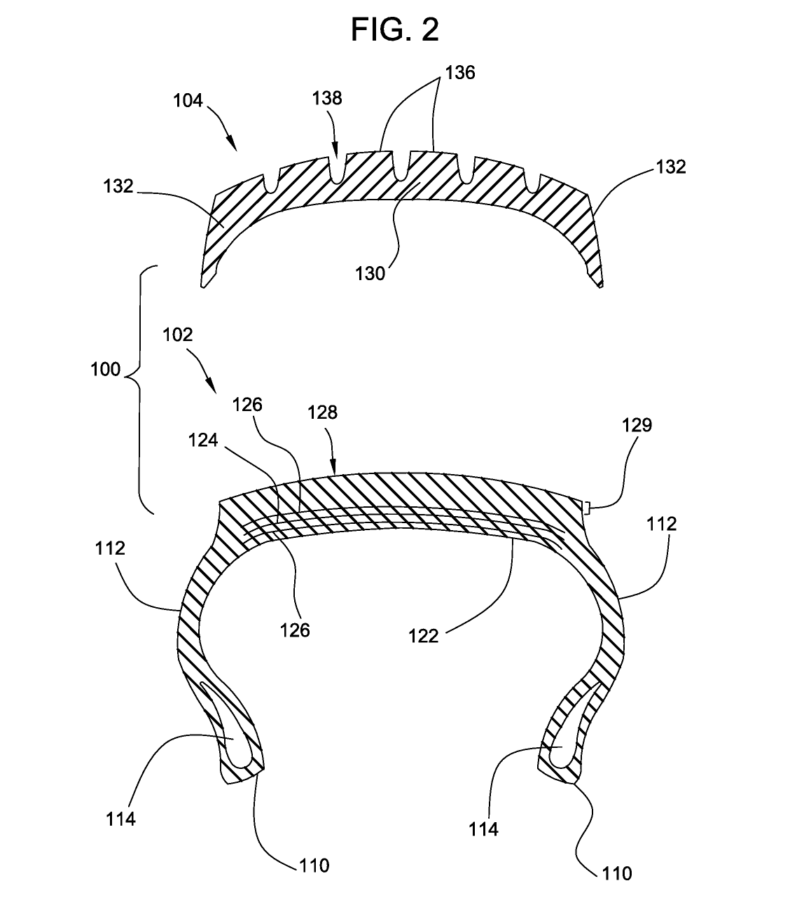

Turning now to the drawings, wherein like reference numbers refer to like elements, there is illustrated in FIGS. 1 and 2 components of a new pneumatic tire 100 in accordance with principles of the present disclosure. Pneumatic tires of the type shown may be used on trucks, buses, construction vehicles, passenger vehicles or any other type of vehicle that travels over a paved road or other surface. Although the tire 100 is illustrated in fragmentary view to better depict the components, it will be appreciated that the complete tire is an annular torus. The pneumatic tire 100 includes a new tire casing or tire casing 102 and a separate new tire tread 104 that may have a tread pattern thereon. The casing 102 provides support and the structural form of the tire that supports the weight of the vehicle when traveling on a road or highway. The casing 102 has generally a U-shaped cross-section that, when attached to a rim, can be inflated with air or other gas, generally at several times that of atmospheric pressure.

The casing 102 is typically made of various plies and layers of different materials and includes various sub-parts that perform different functions. For example, the casing includes distal, enlarged beads 110 formed along depending sidewalls 112 of the U-shaped cross-section. The beads 110 sealingly engage corresponding structures on the rim to secure the tire to the rim. To enlarge the beads 110, a bead filler 114 or bead cord of dense rubber, steal or fabric, is enclosed within the bead. The sidewalls 112 extend radially outwardly from each of the beads 110 and may be made of molded rubber. To join the two opposing sidewalls 112 and complete the U-shaped cross-section, the casing includes a cap 120. The sidewalls 112 and the cap 120 can be integrally molded together and may include several layers. For example, to prevent the pressurized air from escaping the inflated tire, an inner liner 122 made from a gas impermeable rubber or elastomer can be disposed along the radial inner surface of the U-shaped cross-section of the casing 102.

To provide support and puncture resistance, various plies may be circumferentially layered on top of the inner liner 122. These plies can include a steel belt 124 made from closely-spaced, slightly flexible steel cords or wires encased in rubber. A nylon or rubber body ply 126 may be layered over or under the steel belt 124 to sandwich the steel belt. Additionally, casings 102 commonly include a cushion gum to help isolate the steel belt. Other plies may include a body ply made of reinforced woven fabric, nylon, rayon or cushion gum included to prevent the steel belt from wearing against other components. The components are assembled together and encased integrally with each other in rubber. The outermost circumferential surface 128 of the casing is relatively smooth and lacks a pattern or texture.

To provide sufficient traction to propel the vehicle when the tire rotates, the tread 104 is disposed circumferentially along the outer surface 128. The tread 104 can be an extruded or molded profile of rubber and can include tread shoulders 132 on either side which are joined together by an arching tread backing 130. When assembled to the casing 102, the tread shoulders 132 integrally align with and join to the sidewalls 112 while the tread backing 130 extends circumferentially along the smooth surface 128. The tread 104 therefore forms the circumferential exterior of the finished tire 100.

The tread 104 can have a pattern of lugs, grooves, ribs and/or ridges. The pattern can form several lugs 136 separated from each other by gaps or grooves 138. Thin sipes 139 may be defined by the lugs. The grooves 138 can help accommodate and redirect water when the tire 100 is on slick or wetted surfaces to prevent the vehicle from hydroplaning. Many styles of patterns exist for various purposes. For example, tread patterns may be designed for certain weather and precipitation conditions, for improved gas mileage, off-road use, to reduce noise generation, improved wear resistance, etc.

In contrast to the situation where a complete tire including a tire casing and tread is made as a unitary finished product and distributed to various point-of-sales facilities, in embodiments of the present disclosure, a new tire casing and a separate new tire tread are manufactured as separate components and supplied as separate components to a post-production facility, such as a point-of-sale facility or a dealer tire manufacturing facility associated with one or more point-of-sale facilities. The separate casing and tread components can be made either at a single location or at different locations in other embodiments. At the post-production facility (e.g., point-of-sale facility), the casing and the separate tread can be assembled to form a new tire and installed on a customer's vehicle. In embodiments, customers at the point-of-sale facility can be afforded greater selection and the ability to obtain a customized new tire from a large variety of possible tread-casing combinations available from the different types of casings and different types of tire treads. In embodiments, following principles of the present disclosure can help reduce the inventory that is held in stock at the point-of-sale facility in comparison to a conventional supply technique using tires made as a unitary, finished product.

The casing 102 and the tread 104 can be made and cured separately at the respective manufacturing facilities to harden and set the rubber and components. In embodiments in which the casing and the tread are cured separately at the time of manufacture, the curing temperature profile used for the separate components can be selected to suit the specific materials and dimensions of the respective component part. Selective curing of separate parts can help avoid over-cured or under-cured regions within the parts due to excessive or inadequate heat. In addition, the casing and separate tread can include distinct additives which are selected to help enhance the performance characteristics of the particular component.

To make a tire at a post-production facility, such as a point-of-sale facility, the consumer can select a new casing and a separate new tread for assembly into a completed tire. To fit the components together and to remove any oxidized rubber from the casing that may have formed while it was in storage, a layer of rubber can be removed from the outermost circumferential surface 128 of the cap 120 by a buffing process. In some embodiments, the casing may be intentionally provided with excess material, as indicated by arrow 129 in FIG. 1, for this purpose.

In embodiments in which excess material 129 is removed from the casing 102 by buffing the outermost circumferential surface 128 before assembly to the tread 104, the buffing process can allow for adjusting the final dimensions including the outside diameter of the finished tire. For example, removing more or less excess material will correspondingly increase or decrease the outer diameter. The buffing process can also adjust or accommodate the tread depth and other dimensional factors that affect the tire's overall performance. Further, buffing the excess subtread material 129 can expose a layer of unoxidized rubber which can promote the seal between the tread 104 and the casing 102.

The tread 104 is wrapped around the remaining outermost circumferential surface 128 of the casing 102 and the two components are vulcanized in an autoclave or similar device at the point-of-sale facility. Heating the components in the autoclave causes cross-linking between the rubber materials forming an integral bond between the casing and tread. Cushion rubber can be inserted between the casing 102 and the tread 104 before the parts are assembled and joined together to enhance the bond therebetween. In other embodiments, other suitable methods can be employed for assembling the casing 102 and the tread 104.

To facilitate inventory control, for example with respect to the above described assembly method, the disclosure provides a method and system for tracking the separate tire casings and tire treads from distribution to the point-of-sale facilities, assembly at the point-of-sale facilities, and departure from the point-of-sale facilities. Referring to FIG. 1, to implement the inventory control system and method, a first machine-readable identifier 150 can be incorporated into the tire casing 102 at the time it is manufactured at a manufacturing facility. A second machine-readable identifier 152 can be incorporated into the tire tread 104 also at the time it is manufactured. A suitable reader can be used to read the data stored in the identifiers 150, 152 and to send data signals reflecting the data received from the identifiers 150, 152 to an inventory control processor.

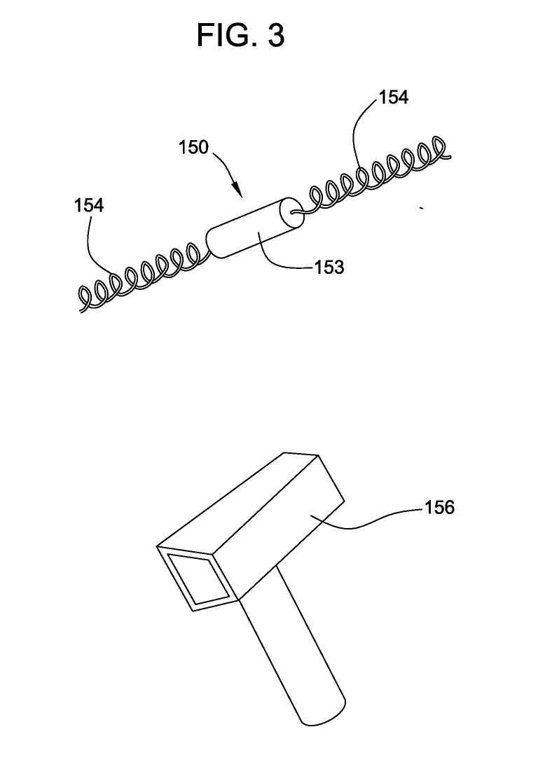

The first and second machine-readable identifiers 150, 152 can be a passive radio frequency identification tag, an active radio frequency identification tag or a visible indicator such as a bar code identifier. An example of a radio frequency identification (“RFID”) tag 150 is illustrated in FIG. 3 and includes a chip portion 153 and an antenna 154. Identification or other useful data can be stored in the chip portion 153, for example, as read-only memory. When the RFID tag 150 is placed in proximity to a reader 156, the electromagnetic field generated by the reader energizes or activates the RFID tag 150. Upon energizing, the chip portion 150 sends identification data to the antenna 154 that transmits or communicates the data as a radio wave receivable by the reader 156. The reader 156 can forward or communicate that data onto other systems, computers or networks.

The information stored in the machine-readable identifier 150 can include data indicating whether the associated tire component is a casing or a tread, its origin of manufacture, date of manufacture and production lot number, and whether the component is a particular type of casing or style of tread. In embodiments, the information can reflect a unique product identifier which is unique to that particular component. Each unit of a tread or casing produced can be assigned a unique product identifier, similar to a serial number, by which the individual unit can be tracked throughout its life. In other embodiments, an inventory control system can use other information, such as information that only identifies whether the component is a casing or tread.

Any suitable means can be used to incorporate the first and second machine-readable identifiers 150, 152 into the respective tire casing 102 and tire tread 104. For example, referring back to FIG. 1, in some embodiments, the first machine-readable identifier 150 can be molded in a rubber portion of the tire casing 102 when the casing is being manufactured Likewise, the second machine-readable identifier 152 can be molded into the rubber of the tire tread 104 during manufacture. This method of incorporation is well-suited when the first and second machine-readable identifiers are RFID tags because the electromagnetic field and radio signal generated by the reader and the RFID tags respectively can travel through the rubber material. When visible indicators such as bar code identifiers are used, the first and second machine readable identifiers can be attached to an exposed portion of the casing and tread.

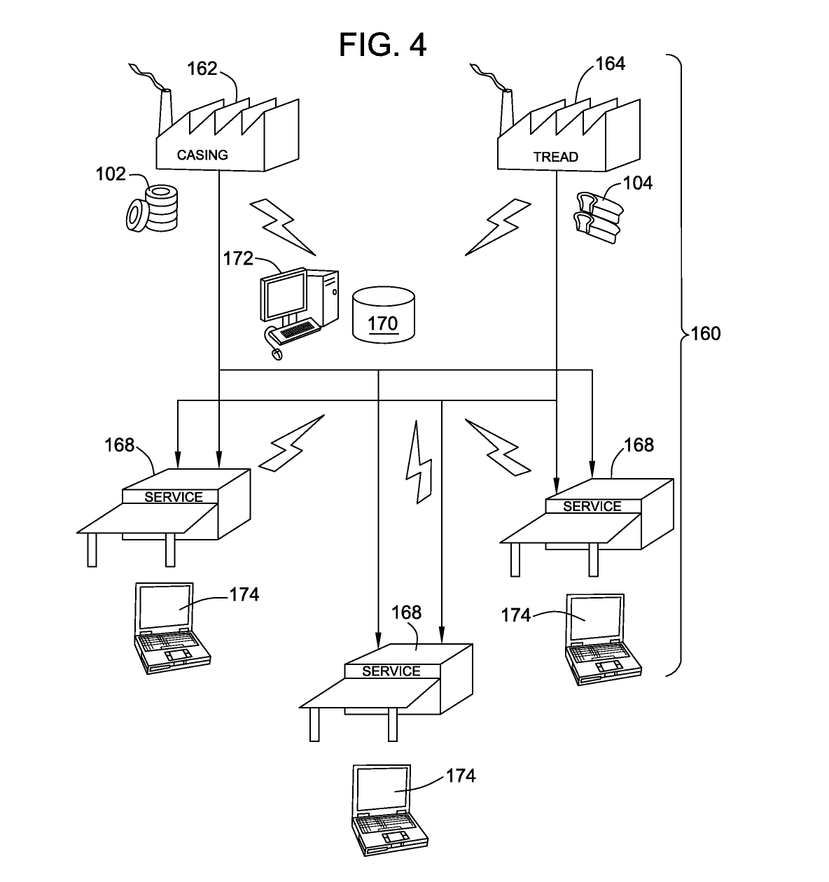

Referring to FIG. 4, there is illustrated an embodiment of an inventory control system 160 for monitoring and tracking tire casings and the tire treads through the new production method. The system includes a casing manufacturing facility 162 for producing new casings 102 and a tread manufacturing facility 164 for making new treads 104. In the illustrated embodiment, the casing manufacturing facility 162 and the tread manufacturing facility 164 are at different locations, but, as indicated above, can be the same facility in other embodiments. The system also includes a plurality of post-production facilities in the form of point-of-sale facilities 168. The point-of-sale facilities 168 can be any suitable facility, such as, tire dealers, tire replacement shops, vehicle maintenance and repair facilities, and new vehicle dealers, for example. Each point-of-sale facility can include tire building equipment adapted to combine certain types of tire casings with certain types of tire treads to produce new finished tires

The point-of-sales facilities 168 can be affiliated with the manufacturing facilities, e.g., as part of the same company or corporation, franchisees of the manufacturing facilities or, in other embodiments, completely distinct and unrelated companies. The point-of-sale facilities 168 can be located so as to increase their accessibility to customers such as along highways or in major population centers. The manufacturing facilities 162, 164 can be located remotely from the point-of-sale facilities 168. The casing manufacturing facility 162 can produce new tire casings 102 and distribute the new casings to the point-of-sale facilities 168. The tread manufacturing facility 164 can likewise produce new treads 102 and distribute the new treads to the point-of-sale facilities 168.

In other embodiments, the post-production facility can comprise a dealer tire manufacturing facility. The dealer tire manufacturing facility can include tire building equipment adapted to combine certain types of tire casings with certain types of tire treads to produce new finished tires. The dealer tire manufacturing facility can be associated with at least one retail outlet associated with the dealer tire manufacturing facility and located within a predetermined distance from the associated dealer tire manufacturing facility.

To track the inventory and distribution of casings 102 and treads 104 at the various point-of-sale facilities 168, the inventory control system 160 can include a database 170 and an associated computer system 172 that can communicate with the point-of-sales facilities and the manufacturing facilities. The database 170 can comprise any suitable data storage device, such as systems based on magnetic, optical, and magneto-optical storage devices, like a hard disk or tape storage, for example. To obtain data at the point-of-sale facilities 168, each facility can also be associated with a computer terminal 174 having input-output systems for data entry. Communication between the computer terminals 174 at the point-of-sale facilities and the database 170 can occur over any suitable communications network including, for example, a web platform over the internet, wireless networks or the like. Although the illustrated embodiment shows a centralized database and associated computer system 172 with all communication being centrally directed, it will be appreciated that in other embodiments this functionality can be distributed among several locations, including at the facilities themselves, using suitable equipment.

Producing new tires at a point-of-sales facility following principles of the present disclosure can allow a customer to customize a new tire from a selection of tire casings and tire treads available at the point-of-sale facility. The manufacturing facilities 162, 164 can send several types of casings 102 and several styles of treads 104 to each point-of-sale facility each with different performance characteristics. Some casing types may exhibit heightened cornering abilities, for example, and others may be structurally reinforced for off-road hauling such as for use on dump trucks, for example. Different tread and casing combinations can provide varying degrees of rolling resistance (energy dissipated when the tire rolls over a surface); wear resistance, noise generation, as well as characteristics for addressing specific weather conditions such as snow or rain. Customers at the point-of-sale facility can select casings and treads based on their driving preferences and/or intended application of the vehicle.

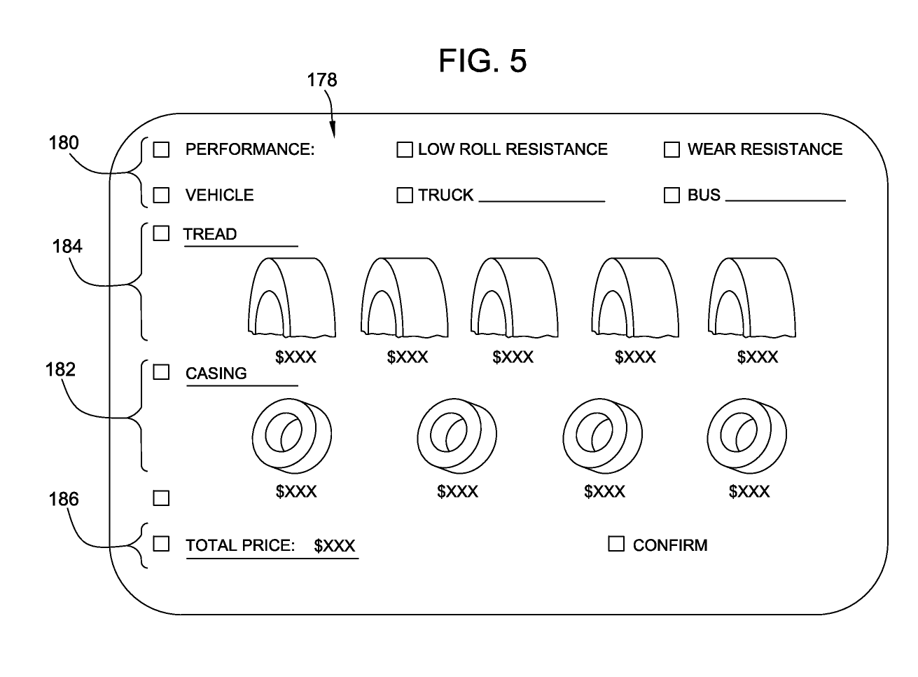

In some embodiments, the selection process can be assisted by the use of a computer system programmed with software stored on a physical computer readable medium having instructions for facilitating the selection process. Referring to FIG. 5, a tire customization and price calculation program can provide, on a visual display device 174 at the point-of-sale facility, a graphical user interface including at least one graphical screen 178 that shows the casing types 182 and the tread styles 184 available for selection. The tire customization program can be in communication with and form part of the computer-assisted inventory control system 160 of FIG. 4.

The screen display 178 may include data entry fields 180 that query the customer for tire performance requirements or preferences. The screen display 178 may also show the types of treads 184 and the types of casings 182 available for selection, in some embodiments based on the customer's responses to the query fields 180. The customer can then select a tread style 184 and casing type 182 for assembly into a new tire. Additional information displayed may include pricing information 186 or other procurement details. In some embodiments, the customization program may include instructions and logic for providing recommendations or suggestions when the selected casing and tread may not provide an optimal match.

In embodiments, the screen display 178 can include data entry fields that query the customer for tire characteristic requirements or preferences. In response to the data entered by the customer, a selection of tire choices can be displayed that correspond to different tread-casing combinations that satisfy or most closely meet the tire characteristics entered by the customer. In embodiments, the tire characteristics can comprise performance characteristics (e.g., rolling resistance, wear resistance, traction capability under different weather and climate conditions, speed rating, and drive-surface-specific features of a tire) and non-performance characteristics (e.g., price).

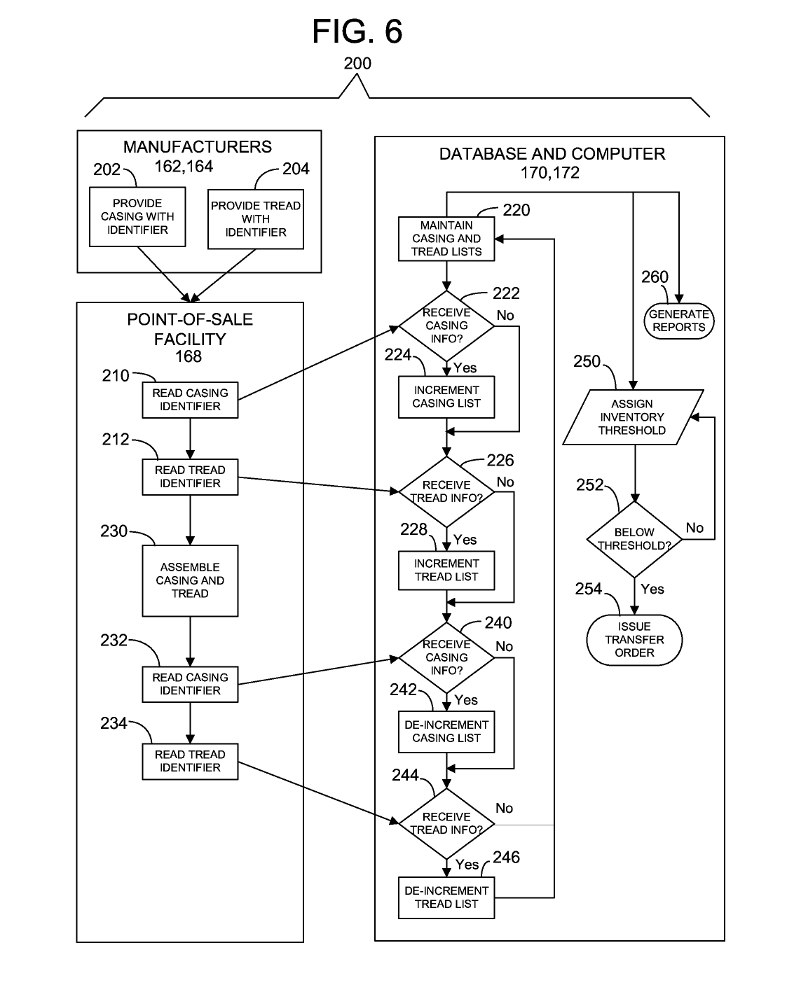

Referring to FIG. 6, there is illustrated an exemplary embodiment of a series of steps for carrying out a method 200 of using the inventory control system according to principles of the present disclosure. It should be noted that the flow chart is an example only and that steps may be omitted, added, rearranged or reordered. In a manufacturing step 202, the casing manufacturing facility manufactures a new pre-cured tire casing installed with the first machine-readable identifier as described above. In a second manufacturing step 204, the tread manufacturing facility manufactures a new pre-cured tire tread installed with the second machine-readable identifier. Both of these components are provided or delivered to the point-of-sale facility 168, although they may pass through other intermediate locations and storage facilities.

Upon arrival at the point-of-sale facility 168, in a first reading step 210 the first machine-readable identifier on the casing is read or scanned with a reader appropriate for the type of machine-readable identifier being used. Data from the first machine-readable identifier is transmitted from the point-of-sale facility to the database 170 over the communication network. Likewise, upon arrival of the newly manufactured tire tread at the point-of-sale facility 168, a second reading step 212 occurs to read data from the second machine-readable identifier associated with the tread. That data is also transmitted to the database 170.

The database 170 can maintain, among other information, a list 220 of new tire casings and new tire treads that are in inventory at the point-of-sale facility 168. The list 220 can include a tire casing tally for each type of tire casing in inventory and a tire tread tally for each type of tire tread in inventory. Each tire casing tally corresponds to a number of units of tire casings in inventory at the post-production facility, and each tire tread tally corresponds to a number of units of tire treads in inventory at the post-production facility. In response to receiving an identification data signal relating to reading one of the machine-readable casing identifiers and indicating the particular tire casing is entering the post-production facility, the tire casing tally can be increased by one unit. Similarly, in response to receiving the identification data signal relating to reading one of the machine-readable tread identifiers and indicating the particular tire tread is entering the post-production facility, the tire tread tally can be increased by one unit.

If the point-of-sale facility 168 transmits an indication that a new tire casing has arrived, an inventory control application stored on a computer readable medium and executed by a suitable processor can be operated to decide, in a decision step 222, to increment the casing list via an incrementing step 224 by one unit in the appropriate casing tally of the type of the new tire casing to account for the increase in casing inventory for that point-of-sale facility 168. Likewise, every time the point-of-sale facility 168 transmits an indication that a new tire tread has arrived, the inventory control application can decide in a second decision step 226 to increment the tread list in a second incrementing step 228. The database 170 can maintain separate lists for each point-of-sale facility among the plurality in the network. Furthermore, in embodiments where the data from the first and second machine readable identifiers includes sufficient detail, the inventory control application can maintain lists in the database 170 of other suitable information so that the inventory control application can be used to track inventory by casing type, tread type, size, manufacture date, performance characteristic etc.

At the point-of-sale facility 168, the customer can select a casing and tread from available inventory that can be assembled into a new tire, on demand, in assembly step 230. After assembly, the new tire can exit the facility. When a new tire is sold or otherwise transferred to a customer, the first machine-readable identifier on the casing used to build the selected tire can be scanned or read at the point-of-sale facility 168 a second time in a third reading step 232 when the casing is removed from inventory and assembled into the new tire. Likewise, the second machine-readable identifier on the tread used to build the tire is also scanned or read a second time in a fourth step 234 when the tread is assembled to the casing.

This information is transmitted to the database 170 by the inventory control application. The information in the database 170 can be assessed by the inventory control application in a third decision step 240 to determine if the appropriate casing tally in the casing list should be decreased in a deducting step 242 by one unit to reflect the exit of a casing from inventory. Likewise, the information can be assessed in a fourth decision step 244 to determine if the information indicates that the tread list should be decreased and, if so, decreases the appropriate tread tally in the tread list by one unit in another deducting step 246. The lists in the database 170 are thereby maintained to accurately reflect entry and exit of treads and casings from inventory at the point-of-sale facility and ensure that adequate inventory is on-hand to supply customer demand.

The information exchange between the point-of-sale facility and the inventory control application preferably occurs via electronic communication over the inventory control system 160. In embodiments, a web-enabled interface is operably arranged with the processor. The web-enabled interface is adapted to exchange information with a network of post-production facilities over the internet.

Each post-production facility is equipped with a reader system adapted to read machine-readable casing identifiers and machine-readable tread identifiers associated with a respective plurality of tire casings and tire treads. The reader system is arranged with the processor through the web-enabled interface and is adapted to transmit a tire component identification data signal to the processor upon reading said identifiers. The data storage device can maintain tire component inventory data for each post-production facility.

The information read from the machine-readable identifiers can be coupled with additional information before transmission. This additional information can reflect whether the transmission should be interpreted as an arrival of a component, an exit of a component or scrap of a component. It should be noted that the terms “arrival” and “exit” at the point-of-sale facility are relative and may reflect entry into and removal from stock rather than physical presence with respect to the facility. Additionally, it may mean arrival into and exit from different stock locations at the same facility, or allocation to and from different job orders.

The computer can be adapted to execute instructions to perform additional operations or queries on the stored data to learn about and manage the inventory at the various point-of-sale facilities 168. For example, the inventory control system can include functionality or logic to manage inventory between a first point-of-sale facility and a second point-of-sale facility and to reallocate inventory between the facilities as needed. To accomplish reallocation, the inventory control system in an assignment step 250 may assign to the first point-of-sale facility a threshold number for the inventory of tire casings or treads below which the inventory of casings or treads should not fall. In embodiments, the inventory control application can be adapted to monitor inventory levels and inventory usage at each post-production facility and to issue a re-allocation order to transfer at least a portion of inventory at a selected post-production facility to another post-production facility based upon at least one of inventory levels and inventory usage.

The inventory control application can query the updated lists in the database 170 in a threshold query step 252 to determine if the inventory for a particular point-of-sale facility is above or below the assigned threshold number. If below the threshold, the inventory control system can generate a transfer order 254 to transfer more newly manufactured casings or pre-cured treads to the point-of-sale facility. Although the transfer order 254 could go back to the manufacturers 162, 164, the inventory control system can alternatively transmit the order 254 to a second point-of-sale facility that has excess inventory. The inventory of the second point-of-sale facility could be readily determined if the database also maintains inventory lists for that facility. The second point-of-sale facility can transfer some of its excess inventory to replenish inventory at the first point-of-sale facility. An advantage of transferring inventory between first and second point-of-sales facilities is better utilization of inventory and, in situations where the point-of-sale facilities are in close proximity but the manufacturing facility is located at a great distance, reduced delay in procuring the necessary components to assemble a new tire.

In a further refinement, the inventory control application can be used to generate various reports regarding inventory usage and tire assembly in a reporting step 260. For example, the database 170 can include functionality for tracking the elapsed time tire casings and tire treads spend in inventory. In embodiments where the inventory control application tracks and utilizes unique product identifiers, determining the elapsed time in inventory can be accomplished by comparing the date each tire component arrived at and exited the point-of-sale facility.

In embodiments, the inventory control application is adapted to record the time when receiving the tire component identification data signal relating to reading each machine-readable casing identifier and each machine-readable tread identifier. The inventory control application is adapted to store in the data storage device an aging log of casings in inventory according to the time spent in inventory and an aging log of treads in inventory according to time spent in inventory. The inventory control application can be adapted, in response to receiving a tire build order for a particular casing-tread combination, to select a particular tread and a particular casing from the aging logs to satisfy the tire build order. In use, the point-of-sale facility can use the inventory control application to select the tire components using a first-in-first-out procedure such that tire components that have been in inventory the longest amount of time prior to using inventory that was more recently added to inventory.

In embodiments that do not utilize unique product identifiers, determining elapsed time in inventory can be done statistically. Additionally, the database can generate reports regarding which type of casing and style of tread are selected most at the various point-of-sale facilities. The report can further reflect favored combinations of tread styles or patterns with casing types. In addition, by providing geographically and demographically specific information regarding customer preferences and the like, the report can be used for market related activities.

In embodiments, the tire casing and the tire tread are assembled together at the post-production facility to form a new tire, and the inventory control application is adapted to store in a new tire log in the data storage device a unique tire identifier for the new tire. The identification data of the particular tread-casing combination used to create the new tire can be associated with the unique tire identifier in the data storage device.

The disclosure provides, in an embodiment, a method for tracking inventory levels of tire components at a point-of-sale facility. A new manufactured tire casing 102 without a tire tread 104 is provided. The tire casing 102 includes a first machine-readable identifier 150. A new pre-cured tire tread 104 without a casing 102 is provided. The tire tread 104 includes a second machine-readable identifier 152. The first and second machine-readable identifiers 150, 152 are read as the tire casing 102 and tire tread 104 arrive at the point-of-sale facility 168. The tire tread can be attached to the tire casing at the point-of-sale facility to provide a new tire. The first and second machine-readable identifiers 150, 152 are read as the tire casing 102 and tire tread 104 exit the point-of-sale facility 168. In some embodiments, the first and second machine-readable identifiers 150, 152 are selected from the group consisting of a radio frequency identification tag and a bar code identifier.

In another embodiment, an inventory control system for tracking inventory of tire components includes a processor adapted to execute an inventory control application stored on a computer readable medium and a database 170 arranged with the processor and adapted to store tire component inventory data. The inventory control system also includes a plurality of point-of-sale facilities 168. Each point-of-sale facility 168 can receive new manufactured tire casings 102 each having a first machine-readable identifier 150 and new manufactured tire treads 104 each having a second machine-readable identifier 151. Each point-of-sale facility 168 includes a data entry device 174 in electronic communication with the database 170. Identification data from the first and second machine-readable identifiers 150, 152 can be obtained upon arrival of said tire casings 102 and said tire treads 14 at the point-of-sale facilities 168 and said identification data are communicated to the database 170. Additionally, identification data from the first and second machine readable identifiers 150, 152 are obtained upon exit of said tire casing 102 and said tire treads 104 at the point-of-sale facilities 168 and said identification data are electronically communicated to the database 170.

The inventory control system's database maintains a list of tire casings 102 per point-of-sale facilities 168 and a list of tire treads 104 per point-of-sale facilities. The inventory control system can include logic 224 to increment the casing list upon arrival of a tire casing 102 at the point-of-sale facility 168 and logic 228 to increment the tread list upon arrival of a tire tread 104 at the point-of-sale facility. The inventory control system can also include logic 242 to de-increment the casing list upon exit of a tire casing 102 from the point-of-sale facility 168 and logic 246 to de-increment the tread list upon exit of a tire tread from the point-of-sale facility. The inventory control system can also include logic to reallocate tire casings and/or tire treads among the plurality of point-of-sale facilities.

According to an embodiment of the inventory control system, a tire tread 104 can be assembled to a tire casing 102 at the point-of-sale facilities 168 prior to exit. The tire casings 102 can be provided in a plurality of types 182, and the tire treads 104 can be provided in a plurality of styles 184 each tire tread style having a different tire tread pattern. In an embodiment, the inventory control system is adapted to generate a report reflecting which combinations of tire casing type 182 and tire tread styles 184 exit assembled together per point-of-sale facility 168. Embodiments of the inventory control system include logic to determine the elapsed time between the arrival of each tire casing and each tire tread and the component's respective exit from the point-of-sale facility.

In another embodiment, a computer-assisted method for tracking inventory of tire components at a point-of-sale facility 168 includes maintaining in a database 170 a first list of new manufactured tire casings 102 in inventory at the point-of-sale facility and a second list of new manufactured tire treads 104 in inventory at the point-of-sale facility. A first indication that a new manufactured tire casing 102 has arrived is received at the database 170 from the point-of-sale facility 168. A second indication that a new manufactured tire tread 104 has arrived is received at the database 170 from the point-of-sale facility 168. The first list and the second list are respectively incremented to reflect the arrival of the new manufactured tire casing 102 and the new manufactured tire tread 104 in response to receiving the first and second indications. A third indication that a new manufactured tire casing 102 has exited the facility is received from the point-of-sale facility. A fourth indication that a new tire tread 104 has exited the facility is received from the point-of-sale facility. The first list and the second list are respectively de-incremented to reflect the exit of the new manufactured tire casing and the new manufactured tire tread in response to receiving the third and fourth indications.

In other embodiments, the method can further comprise the step of receiving a fifth indication along with the third and fourth indication. The fifth indication can indicate that the new manufactured tire casing 102 and new manufactured tire tread 104 exited the point-of-sale facility assembled together.

In some embodiments, the first list further reflects the type 182 of the new manufactured tire casings 102 at the point-of-sale facility 168, and the second list reflect the style 184 of the new manufactured tire treads 104 at the point-of-sale facility. In some embodiments, the method further includes the steps of determining the elapsed time between arrival and exit at the point-of-sale facility 168 of the new manufactured tire casing 102 and determining the elapsed time between arrival and exit at the point-of-sale facility of the new manufacture tire tread 104.

In other embodiments, the central database communicates with a second point-of-sale facility and maintains first and second lists respectively for new manufactured tire casings and new manufactured tire treads in inventory at the second point-of-sale facility.

In some embodiments, the method includes the step of determining from the first list of new manufactured tire casings and/or the second list of new manufactured tire treads in inventory at the first point-of-sale location if inventory of the tire casings and/or tire treads is below a threshold number. If so, a transfer order can be transmitted to the second point-of-sale facility to transfer a new tire casing and/or a new tire tread from inventory to the first point-of-sale facility.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An inventory control system for tracking inventory of tire components comprising:
a tangible, computer-readable medium having computer-executable instructions stored thereon, the computer-executable instructions comprising an inventory control application;
a processor adapted to execute the inventory control application contained on the computer-readable medium;
a data storage device operably arranged with the processor, the data storage device adapted to store tire component inventory data;
a plurality of tire casings, each including a machine-readable casing identifier associated with the tire casing and including casing identification data;
a plurality of tire treads, each including a machine-readable tread identifier associated with the tire tread and including tread identification data;
a reader adapted to read the machine-readable casing identifiers and the machine-readable tread identifiers, the reader arranged with the processor and adapted to transmit a tire component identification data signal to the processor upon reading each of said identifiers, said tire component identification signal including the respective identification data;
wherein the inventory control application includes computer executable instructions adapted to update the tire component inventory data in the data storage device in response to receiving the tire component identification data signal.

2. The inventory control system of claim 1, wherein the tire component inventory data includes a tire casing tally corresponding to a number of units of tire casings in inventory at a post-production facility and a tire tread tally corresponding to a number of units of tire treads in inventory at the post-production facility.

3. The inventory control system of claim 2, wherein the inventory control application includes computer executable instructions adapted to:
in response to receiving the identification data signal relating to reading one of the machine-readable casing identifiers and indicating said tire casing is entering the post-production facility, increasing the tire casing tally by one unit,
in response to receiving the identification data signal relating to reading one of the machine-readable tread identifiers and indicating said tire tread is entering the post-production facility, increasing the tire tread tally by one unit.

4. The inventory control system of claim 3, wherein the inventory control application is adapted to record the time when receiving the tire component identification data signal relating to reading each machine-readable casing identifier and each machine-readable tread identifier, to store in the data storage device an aging log of casings in inventory according to the time spent in inventory and an aging log of treads in inventory according to time spent in inventory.

5. The inventory control system of claim 4, wherein the inventory control application is adapted, in response to receiving a tire build order for a particular casing-tread combination, to select a particular tread and a particular casing from the aging logs to satisfy the tire build order.

6. The inventory control system of claim 5, wherein the inventory control application is adapted to select the particular tread and the particular casing following a first-in-first-out procedure.

7. The inventory control system of claim 3, wherein the inventory control application includes computer executable instructions adapted to:
in response to receiving the tire component identification data signal relating to reading one of the machine-readable casing identifiers and indicating said tire casing is exiting the post-production facility, decreasing the tire casing tally of the tire component by one unit,
in response to receiving the tire component identification data signal relating to reading one of the machine-readable tread identifiers and indicating said tire tread is exiting the post-production facility, decreasing the tire tread tally by one unit.

8. The inventory control system of claim 7, wherein the tire casing and the tire tread are assembled together at the post-production facility to form a new tire, and the inventory control application is adapted to store in a new tire log in the data storage device a unique tire identifier for the new tire and associate with the unique tire identifier the particular tread-casing combination used to create the new tire.

9. The inventory control system of claim 7, wherein the inventory control application is adapted to determine elapsed time between each tire casing and each tire tread entering and exiting the post-production facility.

10. The inventory control system of claim 7, wherein the inventory control application is adapted to monitor the tire casing tally, and, if the tire casing tally falls below a threshold value, to issue a transfer order to transfer additional tire casings to the post-production facility, and the inventory control application is adapted to monitor the tire tread tally and, if the tire tread tally falls below a threshold value, to issue a transfer order to transfer additional tire treads to the post-production facility.

11. The inventory control system of claim 3, wherein the tire casings in inventory comprise a plurality of different types, the tire component inventory data includes a corresponding tire casing type tally corresponding to a number of units of each type of tire casing in inventory at the post-production facility.

12. The inventory control system of claim 11, wherein the tire treads in inventory comprise a plurality of different types, the tire component inventory data includes a corresponding tire tread type tally corresponding to a number of units of each type of tire tread in inventory at the post-production facility

13. The inventory control system of claim 1, further comprising:
a web-enabled interface operably arranged with the processor, the web-enabled interface adapted to exchange information with a network of post-production facilities over the internet;
for each post-production facility, a reader system adapted to read machine-readable casing identifiers and machine-readable tread identifiers associated with a respective plurality of tire casings and tire treads, the reader system arranged with the processor through the web-enabled interface and adapted to transmit a tire component identification data signal to the processor upon reading said identifiers.

14. The inventory control system of claim 12, wherein the data storage device maintains tire component inventory data for each post-production facility.

15. The inventory control system of claim 14, wherein the inventory control application is adapted to monitor inventory levels and inventory usage at each post-production facility and to issue a re-allocation order to transfer at least a portion of inventory at a selected post-production facility to another post-production facility based upon at least one of inventory levels and inventory usage.

16. A computer-implemented method for tracking inventory of tire components at a post-production facility comprising:
maintaining in computer readable memory a first list of tire casings at a post-production facility and a second list of tire treads at the post-production facility;
receiving a first indication that a tire casing has arrived at the post-production facility;
receiving a second indication that a tire tread has arrived at the post-production facility;
incrementing the first list and the second list respectively to reflect arrival of the tire casing and the tire tread at the post-production facility in response to receiving the first and second indications.

17. The method of claim 16, further comprising:
receiving a third indication that a tire casing has exited the post-production facility;
receiving a fourth indication that a tire tread has exited the post-production facility; and
decreasing the first list and the second list respectively to reflect exit of the tires casing and the tire tread from the post-production facility in response to receiving the third and fourth indications.

18. The method of claim 16, further comprising:
receiving a fifth indication that the new manufacture tire casing and the new manufacture tire tread exited from the point-of-sale facility assembled together.

19. A method for tracking inventory levels of tire components at a post-production facility comprising:
reading a first machine-readable identifier associated with a tire casing entering the post-production facility;
in response to reading the first machine-readable identifier entering the post-production facility, increasing a tire casing tally by one unit;
reading a second machine-readable identifier associated with a tire tread entering the post-production facility;
in response to reading the second machine-readable identifier entering the post-production facility, increasing a tire tread tally by one unit;
combining the tire casing and the tire tread to form a new tire;
reading the first machine-readable identifier and the second machine-readable identifier when the tire casing and the tire tread exit the post-production facility as the new tire;
in response to reading the first machine-readable identifier exiting the post-production facility, decreasing the tire casing tally by one unit;
in response to reading the second machine-readable identifier exiting the post-production facility, decreasing the tire tread tally by one unity.

20. The method of claim 19, further comprising:
creating a unique tire identifier associated with the new tire and the particular tread-casing combination.
